(19) United States
(12) Patent Application Publication
(10) Pub. No.: US 2004/0015443 A1
(43) Pub. Date: Jan. 22, 2004

(54) Flyer creator and dispersal system

(76) Inventor: Thomas C. McCoy, Atlanta, GA (US)

Correspondence Address: TECHNOPROP COLTON, L.L.C., P O BOX 567685, ATLANTA, GA, 311567685

(21) Appl. No.: 10/613,727

(22) Filed: Jul. 3, 2003

Related U.S. Application Data
(60) Provisional application No. 60/394,163, filed on Jul. 3, 2002.

(51) Int. Cl. G06F 17/60

(52) U.S. Cl. 705/50

(57) ABSTRACT

A method and system for the entry of information about a property, the incorporation of this information into an informational flyer for the property, and the storage, viewing and distribution of the flyer.

STATEMENT OF RELATED APPLICATIONS

This patent application is based on and claims priority on U.S. Provisional Patent Application No. 60/394163 filed on Jul. 3, 2002.

### BACKGROUND OF INVENTION

1. Technical Field.

The present invention generally relates to the real estate selling and buying field and more specifically relates to a system and method for electronically creating and dispersing flyers and other information regarding specific real estate properties.

2. Prior Art.

Traditionally a real estate agent uses paper flyers as a way to market their residential home listings to other real estate agents around town. Agents will create the flyer themselves or have their secretary create the flyer for them. A flyer includes many different kinds of information to help an interested agent or buyer to determine if this home listing is something their client or they will be interested in. A real estate agent uses several different methods of dispersing their flyers. The different methods of flyer dispersal are costly and time consuming. One method is for an agent to disperse the flyers themselves or hire an assistant to deliver the flyers. Another method is to use a printing and distribution service. This type of service will take a printed flyer template or create a flyer for the agent for an extra fee. This printing service then will distribute for a fee to each and every real estate office to which an agent wishes to market their home listing. Still another method is to leave a supply of the flyers in a box at the home location, typically attached or proximal to the for sale sign.

The traditional ways of dispersing flyers is very costly, time consuming and a large waste of our paper recourses. For example, if an agent using a printing dispersal service to deliver their flyers of their new listings to surrounding real estate offices, that agent can expect to send as many 500 flyers or more for each new listing. If an agent delivered their own flyers they would spend many hours per week to do so. To hire an assistant to make the deliveries for them would be even more costly than a delivery service. The average real estate agent will list one home per month and will advertise, by way of flyer, that new listing two times or more in the first month. This is an average of 1000 pieces of paper every month. There are over 10,000 practicing real estate agents in Atlanta, Ga. US alone. To save over 10,000,000 pieces of paper each month in the Atlanta, Ga. US area alone will have a large effect our paper recourses.

### BRIEF SUMMARY OF THE INVENTION

The invention is directed to a system and method for real estate agents to create and manage flyers for the use in marketing their homes for sale to other real estate agents and potential homebuyers. A preferred embodiment of one method of the present invention includes member real estate agents inputting data regarding specific homes to create flyers, maintaining their own flyer database and maintaining their own electronic marketing page also known as home page through which the flyers can be accessed. Each agent creating a membership can input information for the use of creating his or her own electronic marketing page. The same member agent can submit flyers on their marketing page by posting them electronically or create them using an electronic flyer creator that is part of the invention. The posted flyers can include other types of additional information the agent wishes to attach to their listing. For example, there can be a link that would appear next to the search result of the subject property that could appear as an icon. By clicking on this icon the member can receive accurate information regarding the location of the home to better and more accurately market their new listing. A member agent can have access to their electronic marketing page to give out to customers or clients. In this way an agent can give out the location of the marketing page for the purpose of marketing or so that a selling client can print the flyers themselves from anywhere.

An alternative embodiment of the present invention includes receiving input from other member agents. This is done by entering input for the purpose of searching other agents' flyer databases to locate flyers for themselves or homebuyer prospects. In this way another agent entering input to search for a particular flyer or home can greatly reduce their search time for a particular property or type of property. There also can be an electronic notification system, or alerts, that can enable member agents to receive search results by email at predetermined times, such as daily or weekly, to assist agents in identifying new homes available on the system that fit their clients' needs. Such alerts can include setting up a search by event, location or price range. The searches can be saved, named and set up to notify the agent of new properties fitting their clients' criteria.

Current methods and systems for distributing real estate listing flyers are cumbersome and resource intensive. Thus, there is a need for a real estate flyer creator and distributing method and system that is capable of handling both creating and distributing flyers and other information that is efficient and uses less of our valuable resources. There also is a need for a real estate flyer creator and distributing method and system that allows the input and viewing of the flyers and home information. There is a further need for a real estate flyer creator and distributing method and system that provides an up-to-the-minute ability to input and view flyers and home information. It is to these needs and other related needs that the present invention is directed.

### BRIEF DESCRIPTION OF THE DRAWINGS

FIG. 1 depicts an example agent registration page.

FIG. 2 depicts an example Logon page.

FIG. 3 depicts an example Agent Home Page.

FIG. 4 depicts an example Profile Maintenance Page.

FIG. 5 depicts an example personal web site created using the Profile Maintenance Page.

FIG. 6 depicts an example Delegation Page.

FIG. 7 depicts an example Property Page.

FIG. 8 depicts an example Add Property Page.

FIG. 9 depicts an example Property Maintenance Page.

FIG. 10 depicts an example Duration Maintenance Page.

FIG. 11 depicts an example Events Page.

FIG. 12 depicts an example Caravan Maintenance Page.

FIG. 13 depicts an example Flyer Page.

FIG. 14 depicts an example series of Flyer Maintenance Pages. FIG. 14A depicts the general flyer template selector. FIG. 14B depicts an example drop down list for choosing the style for the Property Template. FIG. 14C depicts an example drop down list for choosing the style for the Realtor Info Template. FIG. 14D depicts an example drop down list for choosing the overall style of the flyer. FIG. 14E depicts an example general flyer template selector as shown in FIG. 13A listing one completed template choice and a second row for creating a second template.

FIG. 15 depicts an example Flyer Template Page for the property.

FIG. 16 depicts an example Realtor Template Page for the realtor.

FIG. 17 depicts an example Flyer Maintenance Page showing some sample flyers.

FIG. 18 depicts an example Search page.

FIG. 19 depicts an example Search Results Page.

FIG. 20 depicts an example Property Display Page.

FIG. 21 depicts an example Saved Searches and Email Alerts Page showing saved searches.

FIG. 22 depicts an example Saved Searches and Email Alerts Page showing an alert.

FIG. 23 depicts an example Alert Maintenance Page.

FIG. 24 depicts an example Advanced Search page.

### DETAILED DESCRIPTION OF THE PREFERRED EMBODIMENTS

The residential real estate flyer creator and dispersal (RREFCD) system of the present invention can be implemented in large part in software (e.g., firmware), hardware, or a combination thereof. In the currently contemplated best mode, much of the RREFCD system is implemented in software, as an executable program, and is executed by a special or general purpose digital computer, such as a personal computer (PC, IBM-compatible, Apple-compatible, or otherwise), workstation, minicomputer, or mainframe computer.

Generally, in terms of hardware architecture, the RREFCD computer includes a processor, memory, and one or more input and/or output (I/O) devices (or peripherals) that are communicatively coupled via a local interface. The local interface can be, for example but not limited to, one or more buses or other wired or wireless connections, as is known in the art. The local interface may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor is a hardware device for executing software that can be stored in memory. The processor can be any custom made or commercially available processor, a central processing unit (CPU) or an auxiliary processor among several processors associated with the RREFCD computer, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory can include any one or a combination of volatile memory elements (e.g., random access memory (RAM, such as DRAM, SRAM, etc.)) and nonvolatile memory elements (e.g., ROM, hard drive, tape, CDROM, etc.). Moreover, the memory may incorporate electronic, magnetic, optical, and/or other types of storage media. Note that the memory can have a distributed architecture, where various components are situated remote from one another, but can be accessed by the processor.

The software in memory may include one or more separate programs, each of which comprises an ordered listing of executable instructions for implementing logical functions. The software in the memory includes the RREFCD system and a suitable operating system (O/S). A non-exhaustive list of examples of suitable commercially available operating systems is as follows: a Windows operating system from Microsoft Corporation, U.S.A., a NetWare operating system available from Novell, Inc., U.S.A., or a UNIX operating system, which is available for purchase from many vendors, such as Sun Microsystems, Inc., Hewlett-Packard Company, U.S.A., and AT&T Corporation, U.S.A. The operating system essentially controls the execution of other computer programs, such as the RREFCD system, and provides scheduling, input-output control, file and data management, memory management, and communication control and related services.

The RREFCD system is a source program, executable program (object code), script, or any other entity comprising a set of instructions to be performed. When the RREFCD system is a source program, then the program needs to be translated via a compiler, assembler, interpreter, or the like, which may or may not be included within the memory, so as to operate properly in connection with the O/S. Furthermore, the RREFCD system can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The RREFCD data is data that is stored by the RREFCD system in memory and contains information related to RREFCD flyers and RREFCD participants (real estate agents, and consumers). In an alternative embodiment the RREFCD data is stored in a memory device that is coupled to the RREFCD computer via an output/input device.

The I/O devices may include input devices, for example but not limited to, a keyboard, mouse, scanner, microphone, etc. Furthermore, the I/O devices may also include output devices, for example but not limited to, a printer, display, etc. Finally, the I/O devices may further include devices that communicate both inputs and outputs, for instance but not limited to, a modulator/demodulator (modem; for accessing another device, system, or network), a radio frequency (RREFCD) or other transceiver, a telephonic interface, a bridge, a router, etc.

If the RREFCD computer is a, workstation, or the like, the software in the memory may further include a basic input output system (BIOS) (omitted for simplicity). The BIOS is a set of essential software routines that initialize and test hardware at startup, start the O/S, and support the transfer of data among the hardware devices. The BIOS is stored in ROM so that the BIOS can be executed when the RREFCD computer is activated.

When the RREFCD computer is in operation, the processor is configured to execute software stored within the memory, to communicate data to and from the memory, and to generally control operations of the RREFCD computer pursuant to the software. The RREFCD system and the O/S, in whole or in part, but typically the latter, are read by the processor, perhaps buffered within the processor, and then executed.

When the RREFCD system is implemented in software, it can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The RREFCD system can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the RREFCD system is implemented in hardware, the RREFCD system can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The communications system includes a RREFCD computer, a selling real estate agent computer, a buying real estate agent computer, a home buyers computer that are coupled to a communications network. In one embodiment, the communications system also includes a home seller computer. The communications network may be the internet, a public switched telephone network (PSTN), an asynchronous transfer mode (ATM) network, a wireless network, or any other suitable means of communication. The selling real estate agent computer, a buying real estate computer, a home buyers computer are used by a selling real estate agent, a buying real estate agent, and a home buyer respectively, and may each be a special or a general purpose digital computer, such as a personal computer (PC; IBM-compatible, Apple-compatible, or otherwise), a workstation, a minicomputer, PDA (personal digital assistant) or a mainframe computer.

In a preferred embodiment of the invention, the communications network is the internet and the RREFCD computer receives hypertext transfer protocol (http) messages from one or more of the other computers, and responds by transmitting hypertext markup language (html) data. The communications language and protocol used, however, are not limited to html and http, and may be any other suitable communications language and protocol.

In an alternative embodiment, the RREFCD computer communicates with a selling real estate agent computer, the buying real estate agent computer, and a potential homebuyer's computer, via different communication means. As a non-limiting example, the RREFCD computer may communicate with a selling real estate agents computer via a private communications link and may communicate with a buying real estate agent's computer, and a potential homebuyers computer via the internet.

In another alternative embodiment, the communications system does not include one or more of the computers. In this alternative embodiment, communications with a participant (selling agent, buying agent, potential buyer) may be achieved via an alternative communications means, such as, for example via a telephone, a facsimile transmission, the Postal Service, or a courier, whereby information received from a participant is entered into the RREFCD computer by an RREFCD system operator, and information transmitted to a participant is retrieved from the RREFCD computer 10 by an RREFCD system operator.

In yet another alternative embodiment, the communications system does in fact include the computers, but communications with one or more participants (selling agent, buying agent, potential buyer) may be achieved via an alternative communications means as discussed above.

The communications system can include more than one of each of the computers listed as follows, one RREFCD computer one selling agent computer, one buying agent computer, and one potential homebuyer computer.

Listed below are the depicting steps that are implemented by the RREFCD system of the present invention. To establishing a membership to use the RREFCD system, a real estate agent or potential homebuyer using their computer must access the RREFCD system via internet. Real estate agents will need to identify themselves by giving the RREFCD system information that only a licensed real estate agent would have. Once the agent has been identified the membership process begins for the real estate agent. The real estate agent has a larger amount of access to the RREFCD system than the potential homebuyer. The real estate agent has access to the flyer posting and other information entry on the RREFCD system associated with him or herself or the home they are selling or buying. The potential homebuyer has a limited amount of access to the RREFCD system.

The potential home buyer sets up a membership by using their computer to access the RREFCD system and then identifying themselves and setting up an account by entering in their personal information such as, address, phone numbers, email address, and password information etc. Real estate agents in order to establish a membership not only need to include the same information a potential buyer would but also enter more detailed information such as agent photographs, company information, company logo and levels of distinction or accreditations etc. Much of this detailed information will be used to create the selling agents home page.

Once a selling real estate agent has set up a membership they will have the option to give posting authority away. For example: Agents in large office often have a secretary who in some cases have the task of creating marketing flyers for the company's selling agents. A selling real estate agent may want to give that secretary the authority to have access to his or her information on the RREFCD system. This way the secretary can add or edit flyers or short reports in the selling agents behalf. The RREFCD system has made arrangements for such authority arrangements. In order to set up an office or group, one or several persons in the group are given permission usually the secretaries to have the authority to make changes for any number of agents in a group. This permission will give that person or persons access to make edits or additions on behalf of any number of agents in the group. At first the secretaries in the office will have access to both short reports (or events) and flyers. Once an agent has set up a membership, an additional membership process will require the agent to answer questions such as; does he or she wish the secretary in their office the authority to make changes on their event and or flyers on their behalf? If an office has not been set up prior to membership, this question would not be presented to a selling agent until the secretaries for that agent's office has been established.

The selling agents home page is a page on the internet identified by an address or URL that an agent can use to market their listings for sale to potential buyers, clients or other real estate agents. The agent can do this by giving away the URL or web page address that gives details about the agent and the agent's homes that are being marketed. The home page can have any type of information he or she would want to make available about themselves to the public he or she wishes to market too. This agent's home page will have other links to other URLs that will direct potential buyer or buying agents to flyers and events used for marketing.

The methods used for a selling real estate agent to post their flyer on the internet. Examples of posting but not limited to: 1. A Selling real estate agent using their computer electronically uploading their marketing flyer in one of several different file formats to the RREFCD computer. 2. Using the RREFCD computer and computer software to create a flyer in PDF or other file format. 3. The selling real estate agent using the U.S. Mail, fax or other mail service to send the flyer to a RREFCD computer associate to scan the flyer on the RREFCD computer.

The first step depicted above goes as follows; the selling real estate agent using his or her own computer logs onto the internet using their ISP and connects to the RREFCD computer. Using the RREFCD software on the RREFCD computer the selling real estate agent can choose to upload a marketing flyer. The selling real estate agent locates the file of the flyer on their computer using the RREFCD software then chooses to upload the content of that file to the RREFCD computer. Once the file is uploaded on the RREFCD computer the selling real estate can view the flyer, print it up or submit for other agents to view.

The second method would require the selling agent to create a flyer using the RREFCD software while on the RREFCD computer via internet. This is done by the RREFCD system that allows the agent to first enter in all the information about the home listed by the selling agent. A sophisticated fill in the blank process collects this information. This can be done by entering in titles of paragraphs an agent would want to uses to describe their listing, and or by listing bullets of information that would describe the details of the home he or she is marketing. There will be no limits on how an agent can describe their home listings for sale. Then he or she chooses one of several flyer templates he or she wishes the flyer to look like. Then the RREFCD system merges the information with the template the agent has chosen, and then attaches the brag sheet he or she wants to include at the bottom of the information creating a flyer. Using the list of detailed information, photos, or artwork gathered from the real estate agent once a membership has been set up creates a brag sheet. The brag sheet is what an agent would like to have printed at the bottom of his or her flyer. This information can include the name of the agent, phone numbers, accreditations, company, company address, company logo, artwork, listing number identifiers, map coordinate, showing instructions etc. An agent can create several brag sheets if she or he wishes depending on the demand for such. The reason for the brag sheet is it saves the agent time and money by not having to retype in information every time he or she wants to create a flyer using the RREFCD system. Once the flyer is completed the RREFCD system then can be used to view the flyer is several different file formats. One of these file formats is PDF, using this file format a potential buyer or buying agent can print up the selling agent created flyer the way the agent intended it to be printed or viewed.

The third method is to use a mail service to deliver a flyer a selling has already created or fax a RREFCD associate a copy of the flyer. Of all three methods this is the least desired method. The reason is because the flyer that is sent will need scanning to be uploaded into the RREFCD system. This removes much of the quality of the original flyer. It takes much more time for a potential buyer or buying agent to pull up a scanned flyer much less print it up.

Using all three of these methods will require one more step before the flyer can appear on the agents home page. The selling agent will need to create a short report for their flyer by using a type of drop down selection and fill in the blank method. This information collected for the short report will be used to locate the property. Such information as price, type of property, address, city, zip code, area of town, map coordinate, agents name, agents office, agents telephone numbers, and maybe a short description etc. The short report is what the buying agent or potential buyer will see as a result when doing a property search. Then from the list of short reports they can choose to view the selling agents flyer or the selling agents home page.

The short report can also be an event that describes when a selling agent will be located on the property he or she are marketing for other real estate agents or potential home buyers to view. An event agent can put together without having a flyer for a means of just making open house or caravan known throughout the buying community. An agent can create a short report or event for periods of time usually a week, and then once expired the short report will disappear. The RREFCD system will keep records of expired short reports and events so agents can reuse them at another time.

The short report or event information can also be used to create an ad in the local newspaper for the Sunday paper. The local newspaper has an electronic service with software that can communicate with the RREFCD system to upload short report information. The local newspapers computer can process the information and create an ad for the selling agent in Sunday's paper.

Once an agent has assembled a flyer and or short report and that flyer or short reports time has expired they go into the selling agents storage for several months. Once in storage on the RREFCD system a selling agent can choose to reuse the information and or flyer over and over again in as many categories as they want. This saves the agent time by not having to recreate the entire flyer every time he or she wants to remarket their listings for sale.

There are also plans for the RREFCD system to print and deliver flyers to the selling agents office to display in their home listings so that there is no need to print up the flyers themselves. An agent will use this service if they wish to have a higher quality of paper or he or she has a sub-standard color printer.

Every service on the RREFCD system with the exception of the short report will cost the selling agent a fee. These fees will be collected electronically using a collection company developed for secure purchasing on the internet. This service will be able to accept credit cards, debit cards, and checks or any other means that is technology available.

The potential buyer much like the buying real estate agent will want to search the RREFCD system when they want to look at potential properties to view and print up flyers. The only access a potential buyer will not have that a buying real estate agent will have is the caravan report.

Traditionally, caravan is when a group of real estate agents get into their cars and personally view homes that they would think a potential client might be interested or view to put into their mental inventory. This way should a potential buyer want to buy a similar home the agent will remember the home they viewed on caravan to show his or her client. Caravan takes place one day a week. In Atlanta this is Tuesday. In other cities it can take place on different days.

The outside buying public (everyone else but real estate agents) does not have any knowledge of caravan day. Caravan day is for the agents only; this is why the potential buyers do not have access to the caravan information. First, a selling agent creates an event for their caravan flyers. The selling agent assigns the dates for the caravan short report and flyer to run. Second the Buying agent defines what he or she is looking for. For example a buying real estate agent and enter one or all of the following: price range, type of home, area or town, number bedrooms, number of bathrooms etc. The agent can do this every time he or she wants to search listings on caravan.

An alternative to entering in a the search criteria every time a buying real estate agent or potential buyer (with the exception of a caravan search) performs a search, both can set up the RREFCD communication system to save the search criteria and dictate the time the buying real estate agent or potential buyer will want to be automatically notified of all the home listings fitting the their search criteria by email, like a virtual mail box. The buying real estate agent or potential buyer can make changes in the search criteria or time of delivery at anytime. If a buying agent has more than one client he or she is searching property for, he or she can set up several search criteria's giving each a name that is associated with each client.

Once a buying agent or potential buyer has received the listings that meet their criteria they can begin to view the flyers of each short report that have a flyer associated with it. If there is not a flyer associated with the event, the real estate agent or potential buyer can always view the agent's home page and gather any contact information they wish. If there is a flyer associated with an event the potential buyer or buying agent can click on the flyer link that will direct the RREFCD system to open up the flyer. The flyer will appear just like the selling agent created. The flyer will print the same way no matter what computer the potential buyer or buying agent is printing from. Either can not only print the flyer but save it as well. If a buying real estate agent wished he or she could copy as many flyers as they wanted to send the copies to their clients via email or on some other kind of media.

Traditionally, there have been situations where real estate agents have falsely listed and marketed a clients listing for sale in a more attractive area in the hopes to get their listing more attention. In most cases this just brings resentment for wasting a buying agents time. Real estate agents use a map book that outlines areas around the city; these area definitions vary from city to city. Agents use these maps as a guide to convey to all other agents the specific location of their listings for sale. The RREFCD system has created a means to keep a real estate agent honest about the location of their listings for sale. This portion of the RREFCD system is called the area director; the area director works something like this. Each page of the map book has number of areas on them, some pages have more than others. Each area has one or more zip codes through them. So in order to list the proper area of a listing for sale a selling agent will need to be sure the home listing is marketed in the proper zip code and on the proper map page coordinate in order to choose the proper area number. An agent will not be able to list a property in the wrong area if the others do not match up.

The RREFCD system will have a management portion of the web site. This will allow someone who has been given permission to have access to all parts of the web site. Parts such as but not limited to, area maintenance, contact maintenance, event maintenance, flyer maintenance, group maintenance, map page maintenance, office maintenance and property maintenance. Area maintenance controls are where the descriptions of an area and number of the areas available are controlled. The contact maintenance is used to manage every agent's information used to create his or her personal web page and brag sheet. The event maintenance is used to edit, add or remove any event such as caravan or open house added to the RREFCD system by an agent. The map page maintenance is used but not limited to determining where the zip codes, areas of town, are located on every map page in a map book used by real estate agents to determine home locations. Flyer maintenance is used to edit, add or remove any flyer added to the RREFCD system by an agent. Group maintenance is used to modify, add, edit or remove a group or persons included or responsible for such groups. Office maintenance is used to make any changes to any real estate office listed on the RREFCD system. Property maintenance is were one can access all the property information that has been listed on the RREFCD system by real estate agents to create their flyers, short reports and brag sheet.

### EXAMPLE

Referring now to the attached figures, the following example is given as an illustrative example of the method of the present invention. This illustrative example is but one embodiment of the invention and is not meant to be limiting in scope.

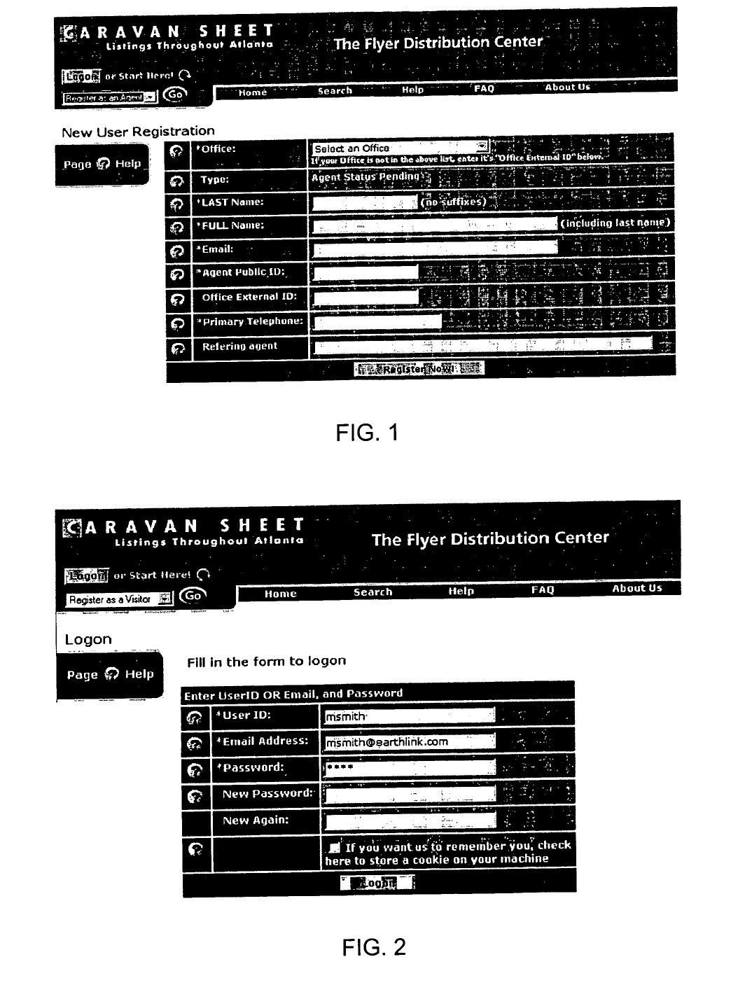

FIG. 1 depicts an example agent registration page. This page can be one of many pages on an interactive website that allows the input of information. This page allows real estate agents to register with the RREFCD system so as to allow the RREFCD system to identify the agents and to allow the agents access to the system. Some example data entry fields include “Office” in which the agent lists the real estate office with which the agent is associated, “Type” which displays the type of agent the agent is relative to the system, “LAST Name” in which the agent enters her last or family name, “FULL Name” in which the agent enters her entire name, “Email” in which the agent enters her email address, “Agent Public ID” in which the agent enters her public identification number given to her by her office listing service, “Office External ID” in which the agent enters an abbreviated version of her office identification name or number, “Primary Telephone” in which the agent enters her primary telephone number, and “Referring Agent” in which the agent enters the name of the agent referring her to the RREFCD system.

The “Office” field can be used to identify the agent's primary office and, after registering or logging in, to supply the agent with a list of tools to help navigate the system. A list of previously entered offices can be contained in a drop down menu for ease of entry. The “Type” field indicates the type of agent the registering agent is. For example, all agents can remain “Pending” unless, for example, the agent receives a new password. Different types of agents can have different access privileges. For example, pending agents may be able only to review the site and perform searches while registered agents may be able to enter properties and create flyers. The “Referring Agent” field can help the system determine which agents are sending more business to the system, and can allow the system operator to reward referring agents.

FIG. 2 depicts an example Logon page. Once the agent has registered with the RREFCD system, the agent will be given a password, which can be sent to the agent at the email address entered during the registration process. The Logon page allows an agent to logon to the system. For example, the agent can enter her “User ID”, her “Email Address”, and her “Password” in the appropriate fields. This page also can allow the agent to change her password. This page further can give the agent the option of allowing the system to remember the agent's logon information by the use of a “cookie”.

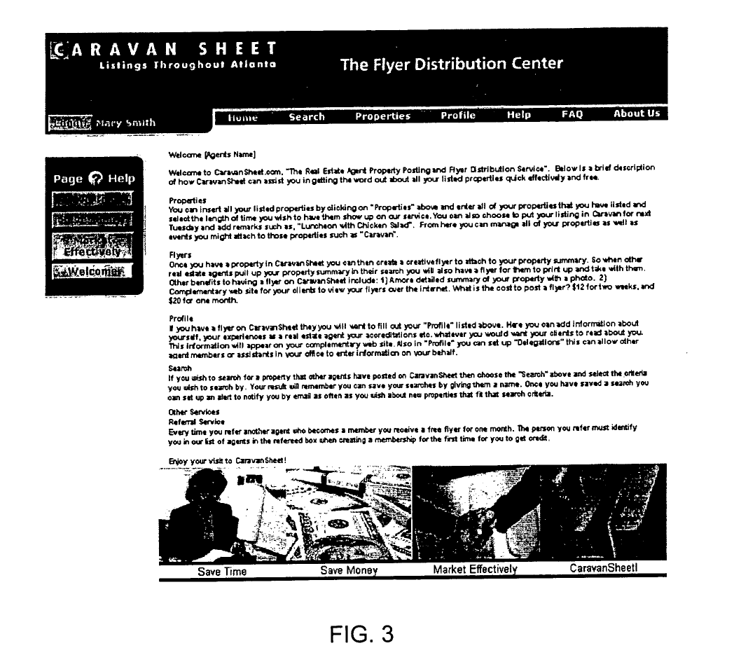

FIG. 3 depicts an example Agent Home Page. Once the agent logs on to the system, a home page or a front page appears on the agent's computer screen. The Agent Home Page can contain any suitable amount of information, such as current events, listings of updates to the system, and instructions on how to navigate the system. The example page shown in FIG. 3 provides basic instructions on how to navigate the RREFCD system, as well as links to the various other pages and features of the system.

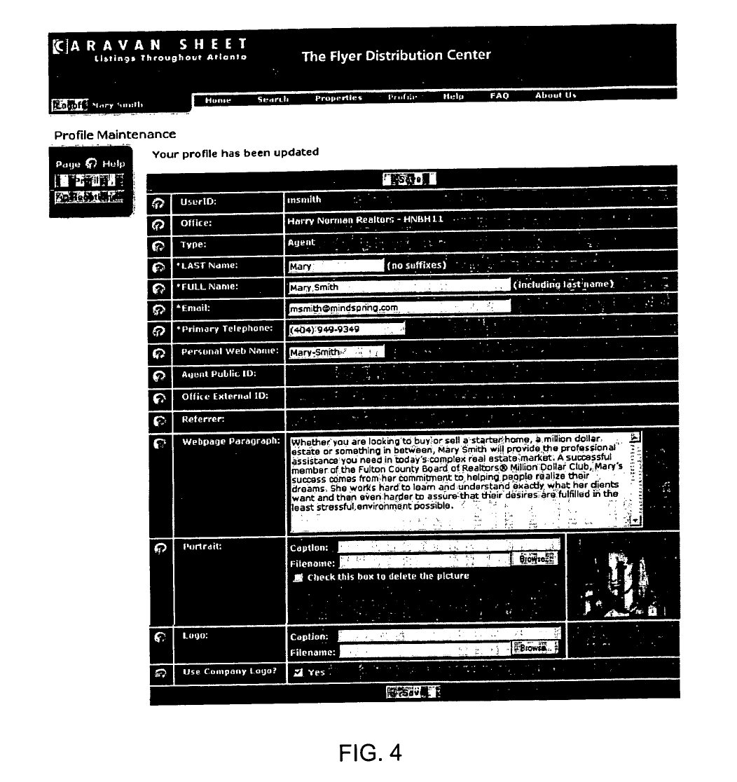

FIG. 4 depicts an example Profile Maintenance Page. Through this page, the agent can personalize the RREFCD system for their use. For example, the RREFCD system can provide each registered agent with a personal web site and through this page the agent can personalize the personal web site. Some example data entry fields include “LAST Name” in which the agent enters her last or family name, “FULL Name” in which the agent enters her entire name, “Email” in which the agent enters her email address, “Primary Telephone” in which the agent enters her primary telephone number, “Personal Web Name” in which the agent can name the web site for later identification and access by herself and others, “Website Paragraph” in which the agent enters a promotional paragraph about herself, “Portrait” in which the agent enters, identifies and uploads a portrait of herself for her personal web site, and “Logo” in which the agent enters, identifies, and uploads a corporate or other log.

The Profile Maintenance Page also can list other previously entered information about the agent and links to other areas of the system. One example link is the “Delegations” link at which the agent can have the ability to give some other person the right to edit the information on the Profile Maintenance Page. For example, an agent may wish to delegate the upkeep of the Profile Maintenance Page ant the personal web site to an assistant or secretary.

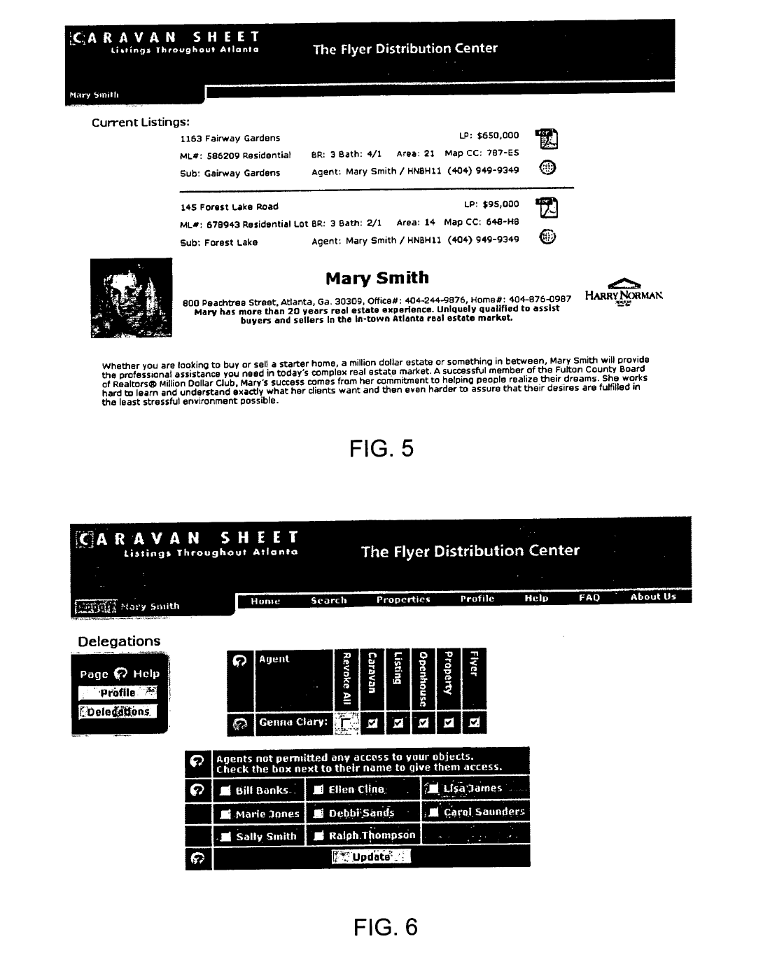

FIG. 5 depicts an example personal web site created using the Profile Maintenance Page. On this example personal web page, the agent's current property listings are listed, along with links to flyers (disclosed in more detail later) for the current property listings. Basic information about the agent, including the “Website Paragraph” also can be displayed on the personal web site.

FIG. 6 depicts an example Delegation Page. On this page, the agent can select who and how much permission another person can have to enter information on their behalf. In the example shown, “Glenna Clary” has been granted permission by agent Mary Smith to enter information regarding “Caravan”, “Listing”, “Openhouse”, “Property”, and “Flyer” on Mary Smith's Profile Maintenance Page. This page also can provide a list of other agents in the registered agent's primary office, or other offices depending on the programming of the RREFCD system.

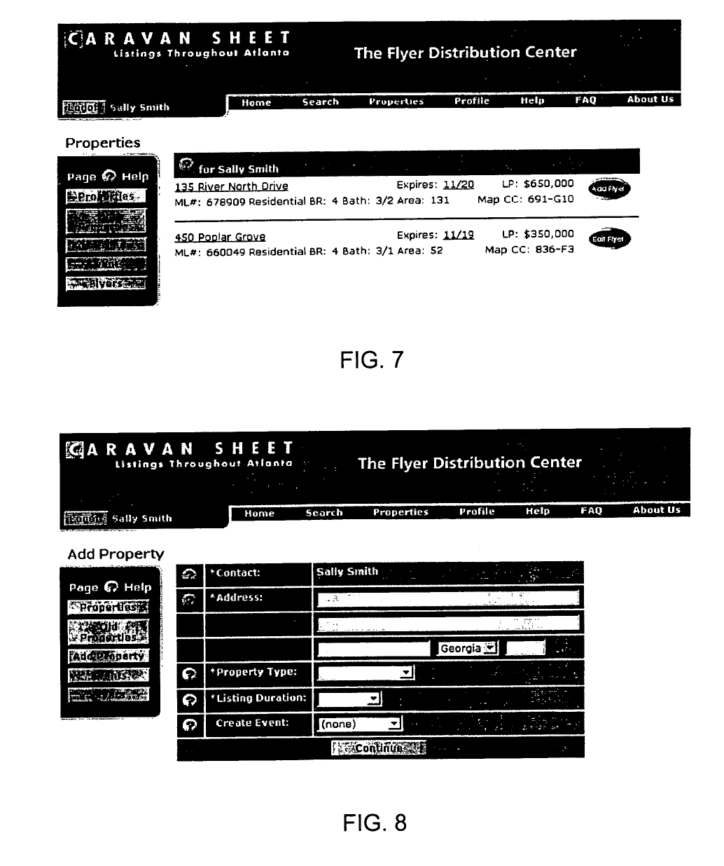

FIG. 7 depicts an example Property Page. On this page, the agent can manage her listed properties. Initially, this page shows the currently listed properties already entered into the RREFCD system. Through this page, the agent can add a flyer (discussed in more detail later) for the current property listings. Also through this page, the agent can access other pages, such as for example “Old Properties”, “Add Property”, Events”, and “Flyers” pages. These various additional pages are discussed next.

FIG. 8 depicts an example Add Property Page. On this page the agent can insert basic information about the property, set the duration of time the agent wishes to run or list the property on the system, and create events such as caravans. On the Add Property Page, the agent first enters preliminary information about the property, such as the “Address”, “Property Type”, “Listing Duration”, and “Create Event”. The data for each of these fields can be entered using drop down menus or by typing. After entering this preliminary information, the agent can proceed to the next page in which more detailed information can be entered about the property.

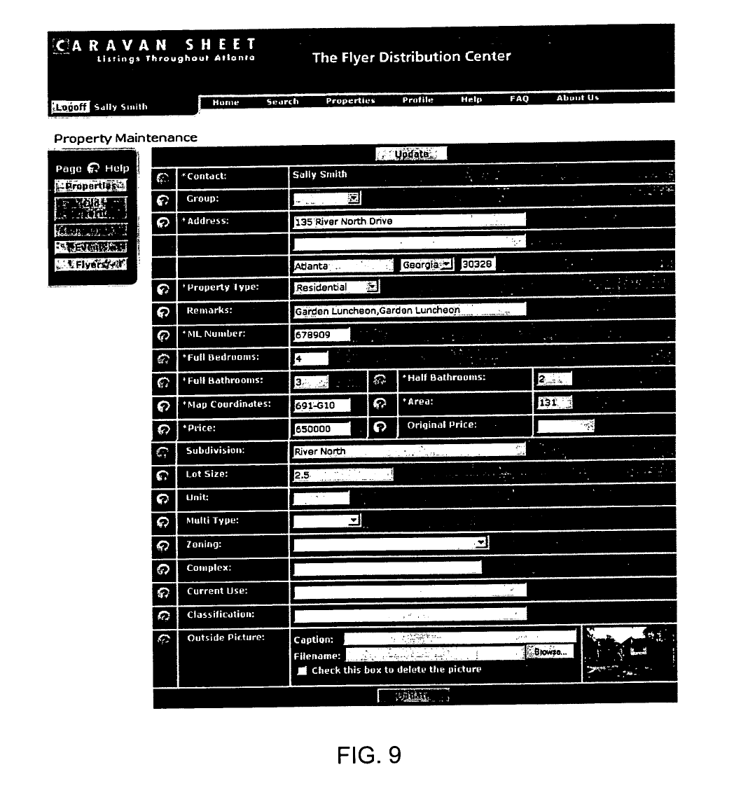

FIG. 9 depicts an example Property Maintenance Page. This page allows the agent to enter more detailed information about the property. This page can be included with the Add Property Page to make one large page, if so programmed. Some example data entry fields include “Contact” which generally is the agent's name, “Group” which identifies the group if a group is marketing the property, “Address” which is the address of the property, “Property Type” which is the type of property such as residential or commercial, “Remarks” which allows the agent to enter a brief remark about the property or an event, “ML Number” which is the listing service number of the property, “Full Bedrooms” which is the number of bedrooms in the property, “Full Bathrooms” which is the number of bathrooms in the property, and “Half Bathrooms” which is the number of half bathrooms in the property. Other example data entry fields include “Map Coordinates” which is the map page and coordinates of the property in a local map book, “Area” which is geographical area in which the property is located, “Price” which is the current asking price of the property, “Original Price” which is the original asking price of the property, “Subdivision” which is the name of the subdivision in which the property is located, and “Lot Size” which is the size (acreage) of the lot on which the property is located. Still other example data entry fields include “Unit” which is the unit number of the property if the property is a condominium or other portion of a larger structure, “Multi Type” which identifies whether the property is a multifamily property, “Zoning” which identifies the type of zoning for the property such ass residential or commercial, “Complex” which is the name of the structure in which the property is located and is useful for condominium or apartment listings, “Current Use” to describe the current use of the property such as residential or commercial, “Classification” to describe the classification of the property such as land or farm, and “Outside Picture” which allows the entry, identification and uploading of a picture of the property.

Once the data for the property has been entered on the Property Maintenance Page, the agent can click on an “Update” button and the completed listing will be shown. This listing now can be made available for other users of the RREFCD system to view.

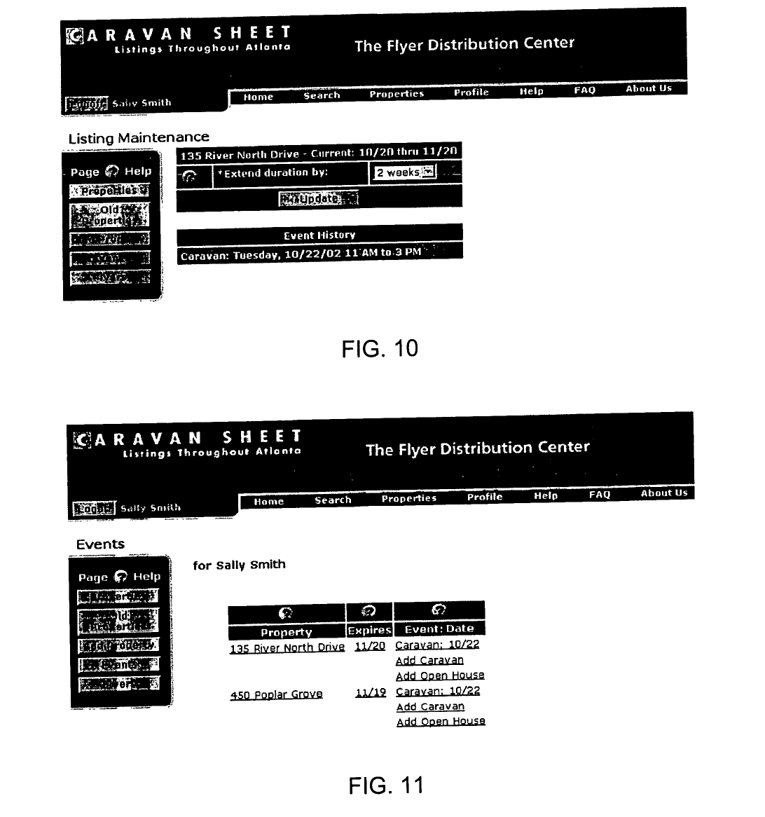

FIG. 10 depicts an example Duration Maintenance Page. Through this page, the agent can select a time duration that the property is listed in the system. The sample page shown lists a caravan for 135 River North Drive that will be listed for two weeks.

FIG. 11 depicts an example Events Page. Through this page, the agent can enter and edit events. The sample page shown lists two events, both of which are caravans. If the agent desires to edit a listed event, the agent can click on the event itself. If the agent desires to add an event, the agent can click on the “Add” lines. Events typically are caravans and open houses, but may include luncheons, teas and the like. If the agent clicks on the event to edit the event, the Caravan Maintenance Page (discussed later) for the event can appear. If the agent clicks on the “Add” line, a new, blank Caravan Maintenance Page can appear.

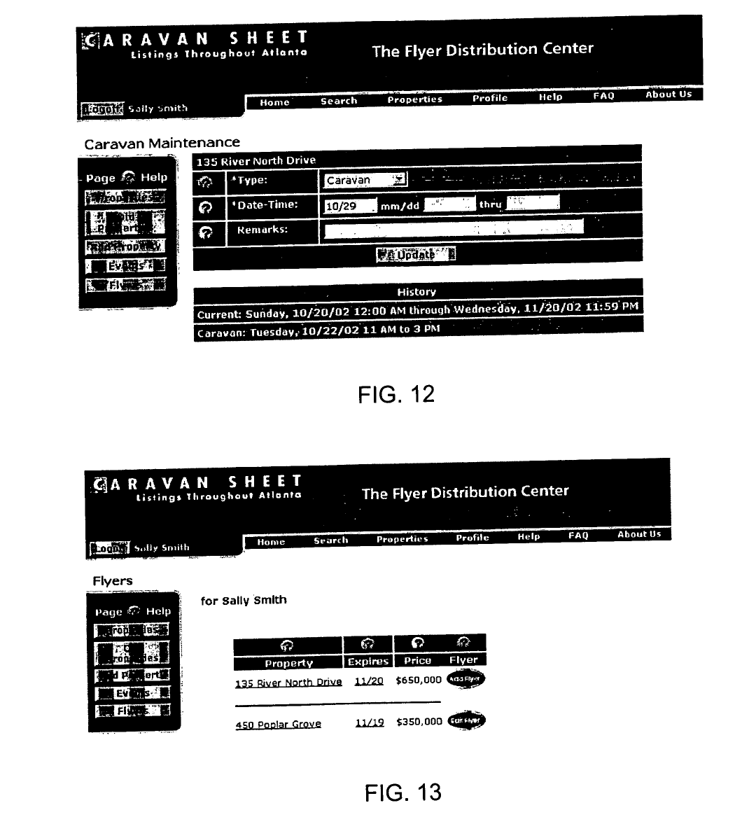

FIG. 12 depicts an example Caravan Maintenance Page. Through this page, the agent can select the type of event to maintain or add, and change or add the information about the event. In the example shown, a caravan is being maintained, as shown in the “Type” field. The agent can enter the “Date-Time” and some remarks about the event. A history field also can be included to show if and how the event has been changed. Clicking on the “Update” button updates the event information.

FIG. 13 depicts an example Flyer Page. It is through this page that the agent can create and maintain flyers about properties. Initially, the Flyer Page lists the agent's currently listed properties. If the agent has not yet created a flyer for a property, an “Add Flyer” button is shown next to the property listing. If the agent has already created a flyer for a property, an “Edit Flyer” button is shown next to the property listing. Clicking on either of these buttons sends the agent to the Flyer Maintenance Page.

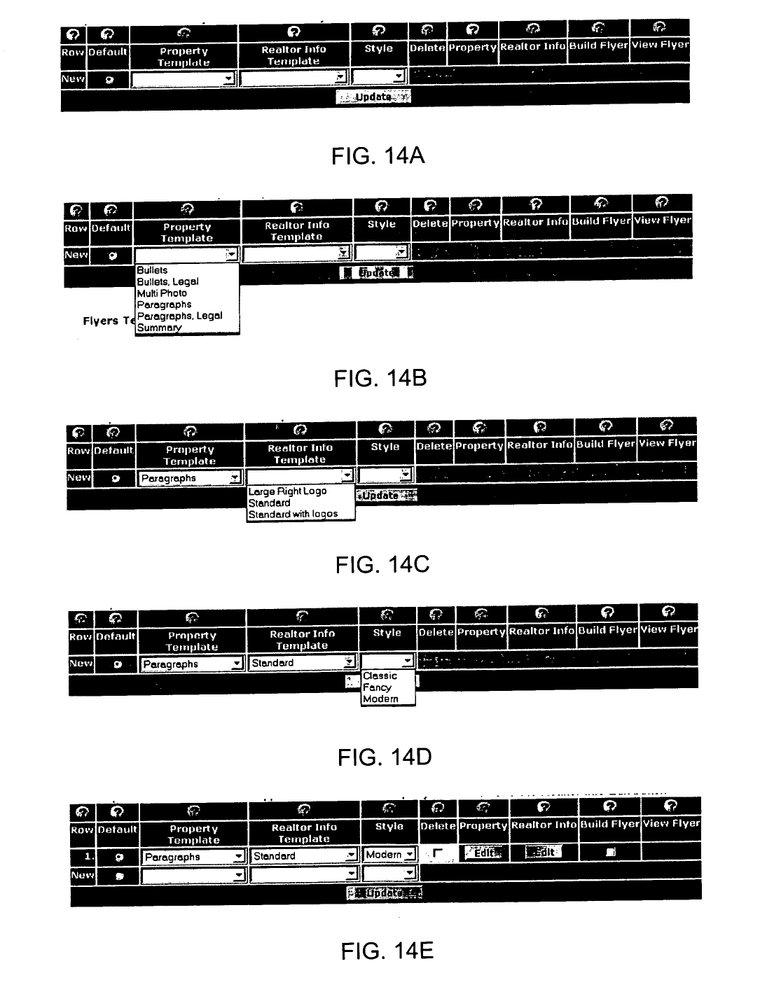

FIG. 14 depicts an example series of Flyer Maintenance Pages to allow the agent to create a flyer. FIG. 14A depicts the general flyer template selector through which the agent can create flyer templates for alter use. The general flyer template selector can includes fields such as “Property Template”, “Realtor Info Template”, and “Style”. Once a flyer template has been created, additional fields can become available, such as “Delete” to delete the selected template, “Property (Edit)” to edit the property template style, “Realtor Info (Edit)” to edit the realtor information style, “Build Flyer” to create the flyer, and “View Flyer” to view the finished flyer. A “default” field also can be included to select which of several previously created flyer templates the agent wishes to use as her default template.

FIG. 14B depicts an example drop down list for choosing the style for the Property Template. Through this template, the agent can create the portion of the flyer regarding the property. FIG. 14C depicts an example drop down list for choosing the style for the Realtor Info Template. Through this template, the agent can create the portion of the flyer regarding the realtor. FIG. 14D depicts an example drop down list for choosing the overall style of the flyer. FIG. 14E depicts an example general flyer template selector as shown in FIG. 14A listing one completed template choice and a second row for creating a second template.

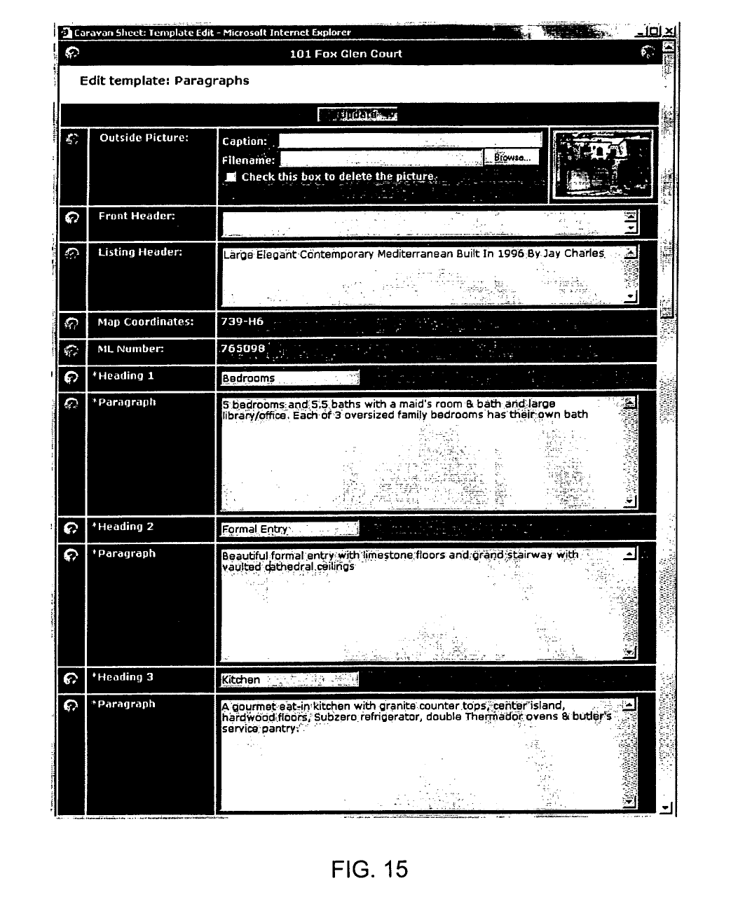

FIG. 15 depicts an example Flyer Template Page for the property. The sample shown is the “Paragraphs” option selected from the drop down list of “Property Template” in FIG. 14. Through this template page, the agent can enter information about a specific property. Some example data entry fields include “Outside Picture” in which the agent can enter, identify and upload a picture of the property, “Front Header” which can contain the property address or other catch phrases, “Listing Header” which can contain a primary heading such as a general informational heading about the property, “Map Coordinates” which provides the map book coordinates for the property, “ML Number” which provides the listing service number for the property, “Heading 1” which can contain a secondary heading about the property, and “Paragraph” which can contain more detailed information about the subject matter of the Heading 1. Additional Headings and Paragraphs can be included to include additional information about the property.

In the example shown in FIG. 15, a flyer is being created for a residential property. No Front Header is given, but a Listing Header briefly describing the property is given. The Map Coordinates and ML Number are taken from previous data entry events. Three different secondary headings are given, namely Heading 1, Heading 2, and Heading 3. A brief descriptive paragraph is associated with each secondary heading. Once all the desired information is entered, the “Update” button is clicked to save the information.

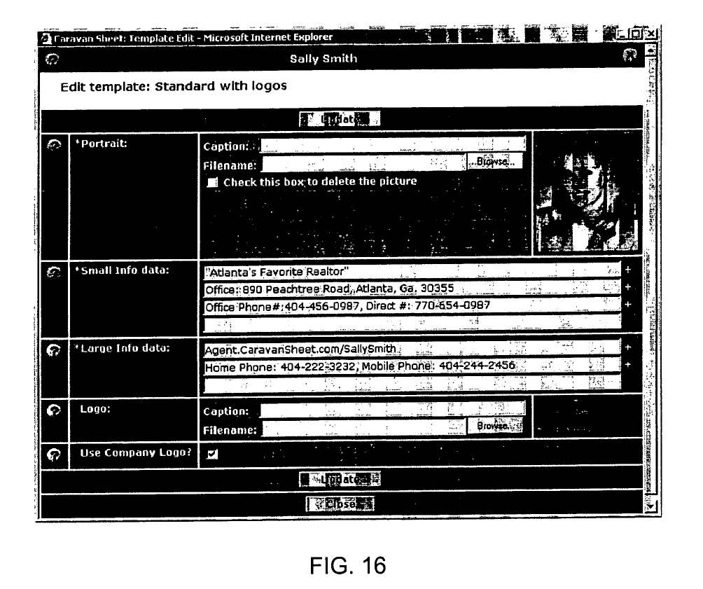

FIG. 16 depicts an example Realtor Template Page for the realtor. Through this page, the agent can create a personalized template including the agent's name, company, address, telephone numbers, web sites and other information. Some exemplary data fields include “Portrait” in which the agent can enter, identify and upload a picture of herself, “Small Info Data” which is for information to be in smaller print on the flyer, “Large Info Data” which is for information to be in larger print on the flyer, and “Logo” in which the agent can enter, identify and upload a corporate logo or the like. The sample shown shows an agent entering some basic information about herself. Once the desired information is entered, the agent clicks the “Update” button to save the information. Clicking the “Update” button also returns the agent to the Flyer Maintenance Page.

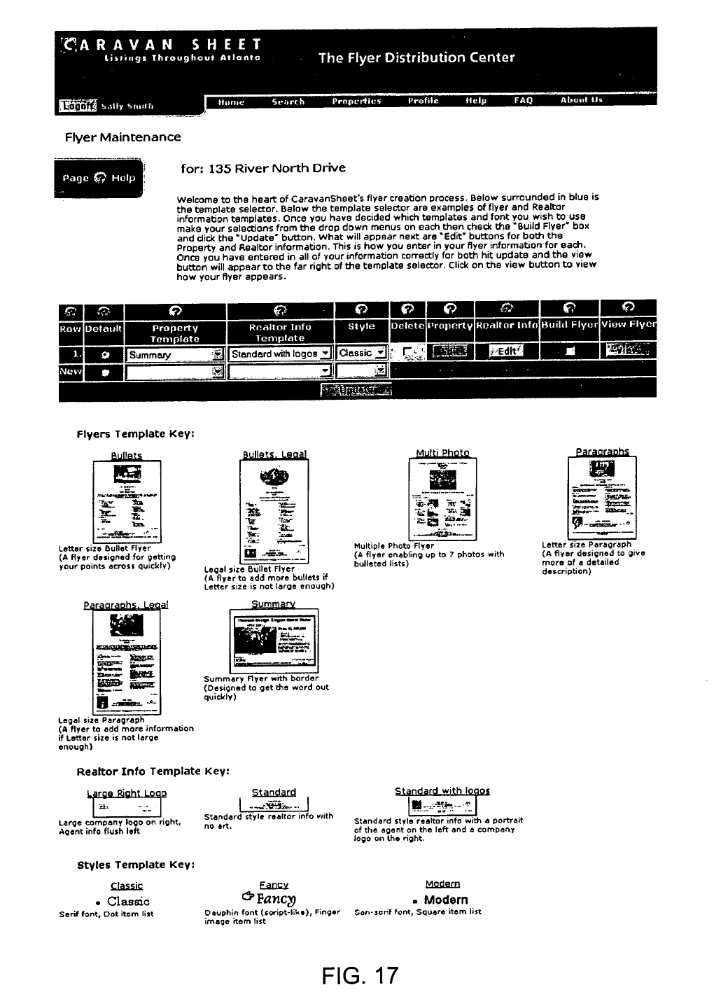

At this stage, the agent is ready to view and review the flyer. A flyer is a typical promotional device to help in selling a property. At a minimum, flyers typically comprise basic information about the property and the realtor. Therefore, once both the flyer template and the realtor template have been populated with information, the flyer can be built. FIG. 17 depicts an example Flyer Maintenance Page showing some sample flyers. As can be seen in the row numbered “1.”, the “View Flyer” filed is now active, having a “View” button below it. The agent clicks on the “View” button to view the flyer she just created.

The flyer now is available for viewing by other agents and prospective buyers. The flyer also now can be distributed electronically through the system to defined groups of people. Flyers can be printed out by the viewing party or sent electronically to others having a potential interest in the property. Having the flyers created, available and distributed electronically saves on paper resources and other costs.

The RREFCD system also can comprise a search feature so that other agents and prospective buyers can search for and view flyers of properties fitting within defined criteria. This can be very helpful when searching for a property to buy. All of the information entered in the previously disclosed pages and entry fields is stored in a database. The search function searches this database.

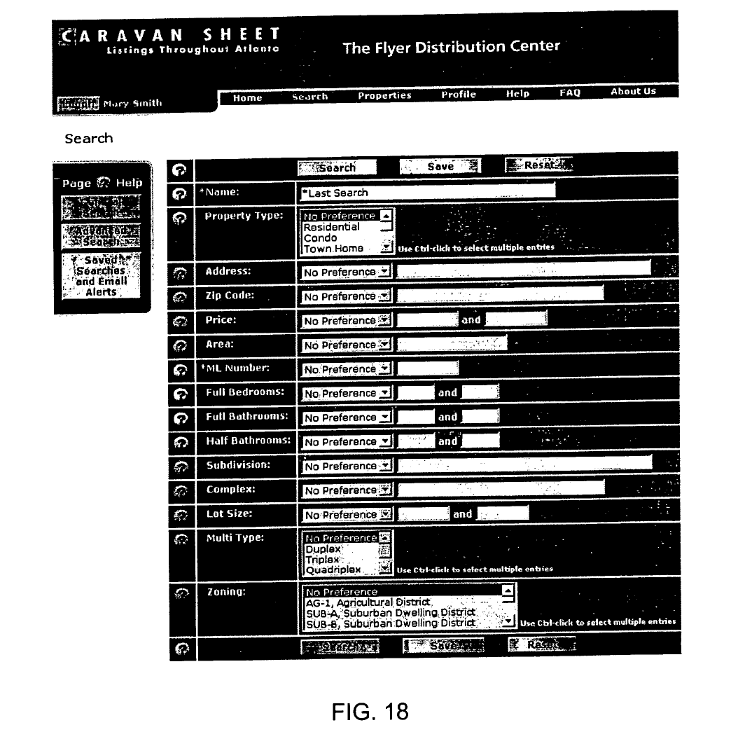

FIG. 18 depicts an example Search page. Through this page, the agent or other user can enter one or more criteria they are looking for in a property and search the database for matching properties. Some exemplary search fields include “Name” in which the agent can name a search for later recall, “Property Type” such as residential or condominium, “Address”, “Zip Code”, “Price”, “Area”, “ML Number”, “Full. Bedrooms”, “Full Bathrooms”, “Half Bathrooms”, “Subdivision”, “Complex”, “Lot Size”, “Multi Type”, and “Zoning”. Each of these fields has been defined previously. The agent can enter information in one or more of these fields to conduct the search.

Searches can be named and saved for later use. For example, in January, the agent may have a client looking for a specific type of home in a certain zip code. In June, the agent may have another client interested in the same type of home in the same zip code. If the agent conducted a search for the first client in January, the agent could save the search criteria and name it generically for the type of search. Then in June the agent could use this same saved criteria to conduct an updated search.

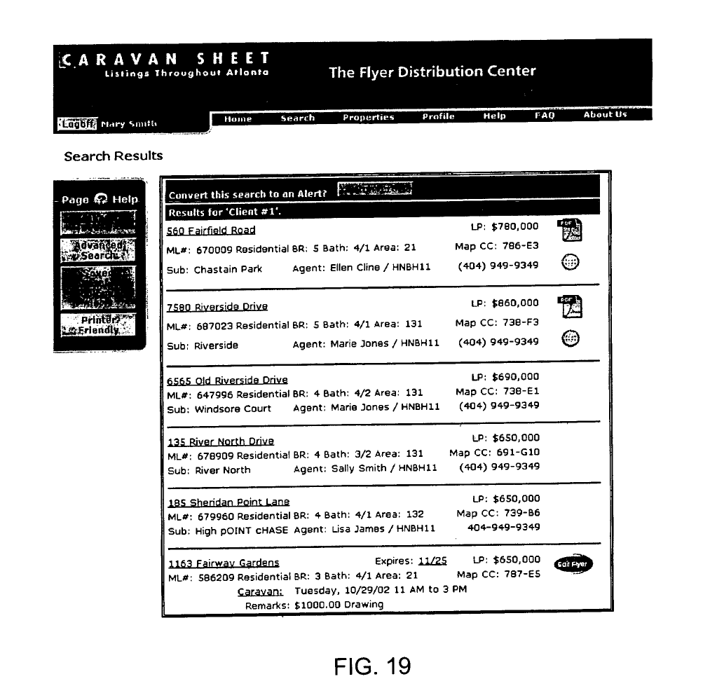

FIG. 19 depicts an example Search Results Page. Depending on how refined the search criteria were will determine how many results are received. Once the search results are displayed, the agent can click on the property address to view the Property Display disclosed later. Alternatively, the agent can click on the Flyer icon and view the flyer. A link to a mapping source can be added so that the agent can obtain a map and/or directions to the property. Further, the search results can be converted to an Alert, which is disclosed later.

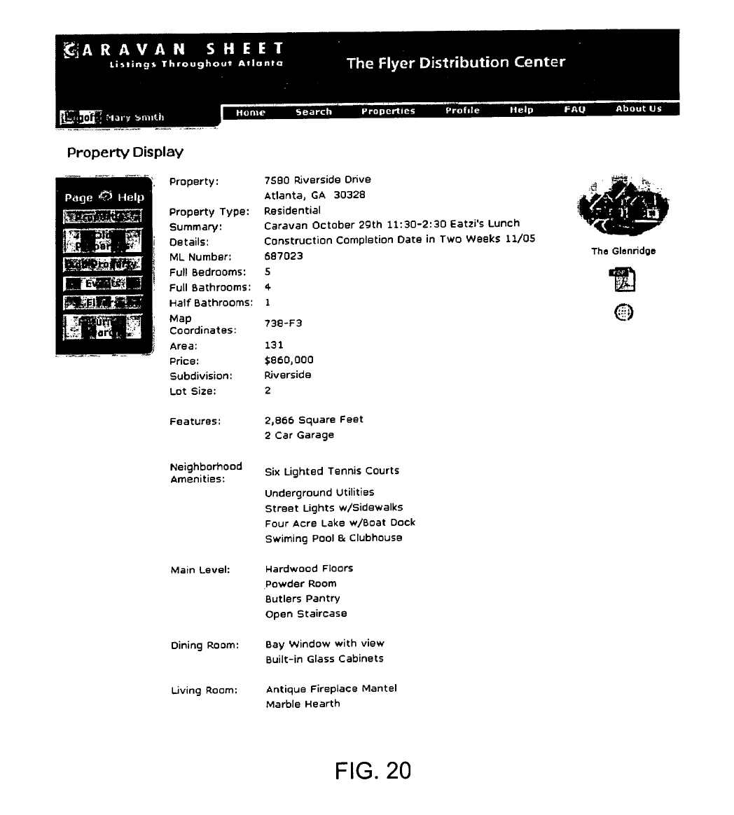

FIG. 20 depicts an example Property Display Page. The Property Display Page is the result of what the agent previously entered in the Property Maintenance Page about a specific listing. If the listing agent has a flyer posted to the property summary, the flyer can be accessed from the Property Display Page. The Property Display Page can give a detailed view of the features of the property including, for example, the type of property, the number of bedrooms and bathrooms, neighborhood amenities, descriptions of various rooms in the property, and a picture.

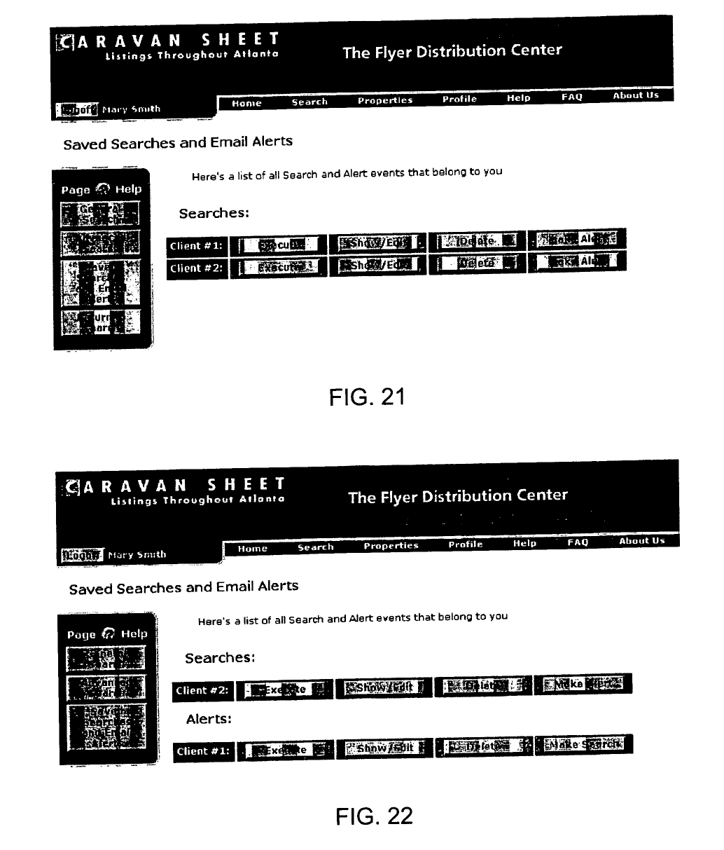

FIG. 21 depicts an example Saved Searches and Email Alerts Page showing saved searches. Once a search has been performed, named and saved, the search will appear on the Saved Searches and Email Alerts Page. The saved searches can be viewed and edited. The saved searches also can be re-executed to create an updated listing of the properties matching the search criteria. Searches also can be converted to alerts.

FIG. 22 depicts an example Saved Searches and Email Alerts Page showing an alert. An alert is an automatic system that carries out the specific search at selected time intervals and alerts the agent if a property fitting the criteria of the search is in the RREFCD system database. If such a property is found, the alert causes the agent to be notified in a selected manner.

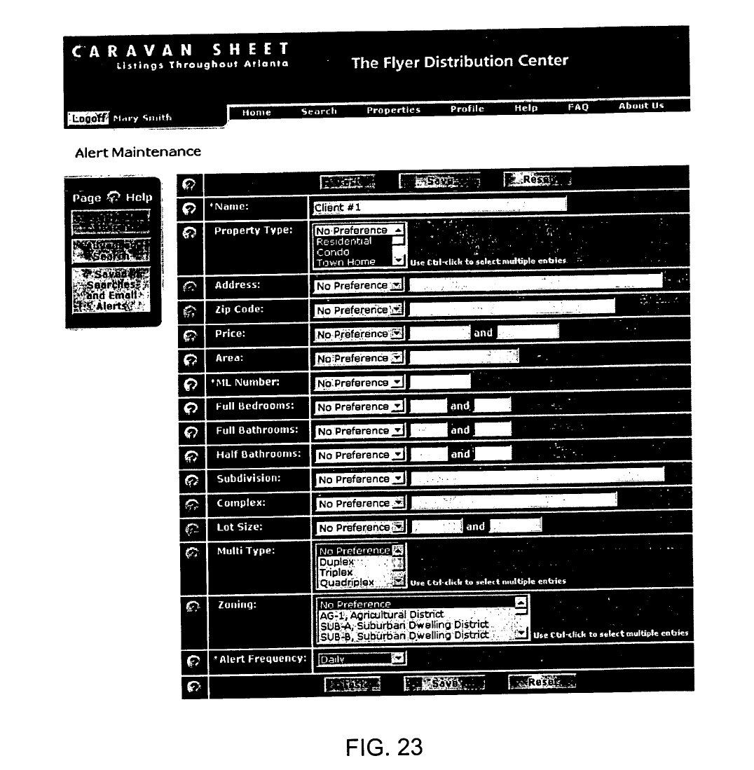

FIG. 23 depicts an example Alert Maintenance Page, which generally is similar to or identical to the Search Page shown in FIG. 18. On this page, the agent can enter the search criteria, in much the same manner as the agent entered the search criteria. Through this page, the agent or other user can enter one or more criteria they are looking for in a property and search the database for matching properties. Some exemplary alert fields include “Name” in which the agent can name a search for later recall, “Property Type” such as residential or condominium, “Address”, “Zip Code”, “Price”, “Area”, “ML Number”, “Full Bedrooms”, “Full Bathrooms”, “Half Bathrooms”, “Subdivision”, “Complex”, “Lot Size”, “Multi Type”, and “Zoning”. Each of these fields has been defined previously. The agent can enter information in one or more of these fields to set the alert.

Alerts can be named and saved for later use. Alerts can be tested to determine whether the alert turns up too many or too few properties. The “Alert Frequency” field allows the agent to enter how often an alert notifies the agent by email or some other method. For example, the agent can set the alert frequency to “Daily” to send an email alert to the agent once a day if properties satisfying the alert criteria are found.

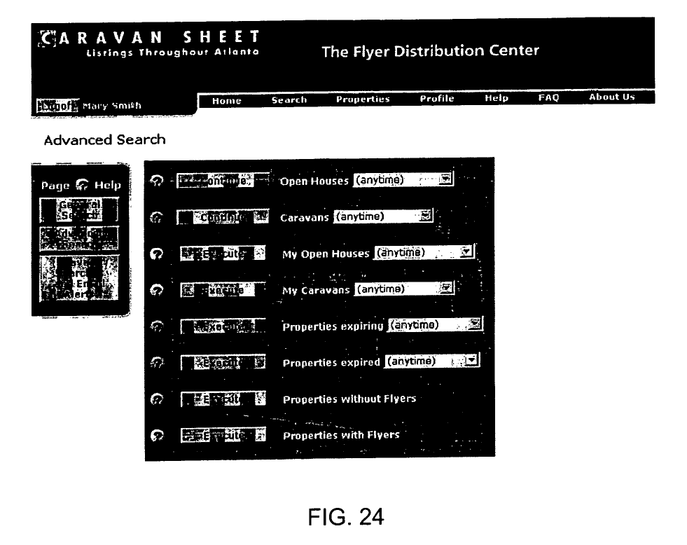

FIG. 24 depicts an example Advanced Search page through which the agent can conduct special searches. Such special searches may include searches for caravans or open houses, searched for expired properties or properties expiring in the near future, and for properties with flyers. Many different advanced search fields can be programmed into the system.

Each of the web pages listed above can be varied both in content and in layout. The example content and layout are meant to provide a basis for understanding the invention and are not meant to be limiting. For example, other data entry fields, drop down menus, and links can be added to any of the pages shown, and still fall within the scope of the invention. One of ordinary skill in the computer programming field can develop and code programs to carry out this invention.

Thus, a system for the entry of information about a property and an agent, the incorporation of this information into a promotional flyer for the property, and the storage, viewing and distribution of the flyer has been disclosed. It should be emphasized that the above-described embodiments of the present invention, particularly, any “preferred” embodiments, are merely possible examples of implementations, merely setting forth a clear understanding of the principles of the invention. Many variations and modifications may be made to the above-described embodiments of the invention without departing substantially from the principles of the invention. All such modifications and variations are intended to be included herein within the scope of this disclosure and the present invention and protected by the following claims.

What is claimed is:

1. A method for the creation of informational materials comprising the steps of:
a. providing for the digital input of data regarding selected specifics related to an item and/or an event;
b. providing for a digital template for organizing the data regarding specifics;
c. entering the data regarding specifics into a digital computational and storage device;
d. organizing the data regarding specifics into the digital template; and
e. providing for the creation of the informational materials based on the data regarding specifics organized into the digital template,
wherein the informational materials comprises an electronic version of the data regarding specifics combined with the digital template.

2. The method as claimed in claim 1, wherein the informational materials comprises a plurality of discrete sections, at least a first of which is a section devoted to information regarding a tangible item and at least a second of which is devoted to information regarding an organizational entity.

3. The method as claimed in claim 2, wherein the tangible item is selected from the group consisting of real property and chattels and the organizational entity is selected from the group consisting of individuals, groups of individuals and commercial enterprises.

4. The method as claimed in claim 3, wherein the tangible item is real property and the organizational entity provides services in the real estate sales and leasing field.

5. The method as claimed in claim 1, wherein the informational materials comprises a plurality of discrete sections, at least a first of which is a section devoted to information regarding the event and at least a second of which is devoted to information regarding an organizational entity.

6. The method as claimed in claim 5, wherein the event is selected from the group consisting of events relating to the sales or leasing of real property and chattels and the organizational entity is selected from the group consisting of individuals, groups of individuals and commercial enterprises.

7. The method as claimed in claim 6, wherein the event is related to the sales or leasing of real property and the organizational entity provides services in the real estate sales and leasing field.

8. The method as claimed in claim 1, wherein the data input is accomplished by a means selected from the group consisting of keyboard entry, touchscreen entry, optical character recognition scanning, file scanning, downloading from a previously created database, audio file entry, video file entry, and combinations thereof.

9. The method as claimed in claim 1, further comprising the step of:
f. making the informational materials available for viewing over a computer network.

10. The method as claimed in claim 1, further comprising the step of:
f. transmitting the informational materials over a computer network.

11. The method as claimed in claim 1, further comprising the step of:
f. making the informational materials available for viewing over a computer network and transmitting the informational materials over a computer network.

12. A method for the creation and dispersing of informational materials regarding the sales and leasing of real property comprising the steps of:
a. providing for the digital input of data regarding selected specifics related to at least one piece of real property and/or at least one event related to the sales or leasing of real property;
b. providing for the digital input of data regarding selected specifics related to at least one organizational entity;
c. providing for a digital template for organizing the data regarding specifics;
d. entering the data regarding specifics into a digital computational and storage device;
e. organizing the data regarding specifics into the digital template; and
f. providing for the creation of the informational materials based on the data regarding specifics organized into the digital template,
wherein the informational materials comprises an electronic version of the data regarding specifics combined with the digital template.

13. The method as claimed in claim 12, wherein the informational materials comprises a plurality of discrete sections, at least a first of which is a section devoted to information regarding the at least one piece of real property and/or the at least one event related to the sales or leasing of real property and at least a second of which is devoted to information regarding an organizational entity selected from the group consisting of entities that provide services in the real estate sales and leasing field.

14. The method as claimed in claim 12, wherein the data input is accomplished by a means selected from the group consisting of keyboard entry, touchscreen entry, optical character recognition scanning, file scanning, downloading from a previously created database, audio file entry, video file entry, and combinations thereof.

15. The method as claimed in claim 12, further comprising the step of:
g. making the informational materials available for viewing over a computer network.

16. The method as claimed in claim 12, further comprising the step of:
g. transmitting the informational materials over a computer network.

17. The method as claimed in claim 12, further comprising the step of:
g. making the informational materials available for viewing over a computer network and transmitting the informational materials over a computer network.

18. A method for the creation and dispersing of informational materials regarding the sales and leasing of real property comprising the steps of:
a. providing for the digital input of data regarding selected specifics related to at least one piece of real property and/or at least one event related to the sales or leasing of real property;
b. providing for the digital input of data regarding selected specifics related to at least one organizational entity;
c. providing for a digital template for organizing the data regarding specifics;
d. entering the data regarding specifics into a digital computational and storage device;
e. organizing the data regarding specifics into the digital template;
f. providing for the creation of the informational materials based on the data regarding specifics organized into the digital template; and
g. making the informational materials available for viewing over a computer network,
wherein the informational materials comprises an electronic version of the data regarding specifics combined with the digital template, and the informational materials comprises a plurality of discrete sections, at least a first of which is a section devoted to information regarding the at least one piece of real property and/or the at least one event related to the sales or leasing of real property and at least a second of which is devoted to information regarding an organizational entity selected from the group consisting of entities that provide services in the real estate sales and leasing field.

19. The method as claimed in claim 18, further comprising the step of:
h. transmitting the informational materials over the computer network.

20. The method as claimed in claim 19, wherein the data input is accomplished by a means selected from the group consisting of keyboard entry, touchscreen entry, optical character recognition scanning, file scanning, downloading from a previously created database, audio file entry, video file entry, and combinations thereof.

21. The method as claimed in claim 20, wherein the data input regarding the selected specifics regarding the at least one piece of real property and/or at least one event related to the sales or leasing of real property is accomplished by downloading from a commercial database dedicated to information regarding real property and the data input regarding the selected specifics regarding the at least one organizational entity is accomplished by downloading from a database previously developed by the at least one organizational entity,

22. A system for the creation of informational materials comprising:
a. means for entering digital input of data regarding selected specifics related to an item and/or an event;
b. a digital template for organizing the data regarding specifics;
c. means for organizing the data regarding specifics into the digital template; and
d. means for creating the informational materials based on the data regarding specifics organized into the digital template,
wherein the informational materials comprises an electronic version of the data regarding specifics combined with the digital template.

23. The system as claimed in claim 22, wherein the informational materials comprises a plurality of discrete sections, at least a first of which is a section devoted to information regarding a tangible item and at least a second of which is devoted to information regarding an organizational entity.

24. The system as claimed in claim 23, wherein the tangible item is selected from the group consisting of real property and chattels and the organizational entity is selected from the group consisting of individuals, groups of individuals and commercial enterprises.

25. The system as claimed in claim 24, wherein the tangible item is real property and the organizational entity provides services in the real estate sales and leasing field.

26. The system as claimed in claim 22, wherein the informational materials comprises a plurality of discrete sections, at least a first of which is a section devoted to information regarding the event and at least a second of which is devoted to information regarding an organizational entity.

27. The system as claimed in claim 26, wherein the event is selected from the group consisting of events relating to the sales or leasing of real property and chattels and the organizational entity is selected from the group consisting of individuals, groups of individuals and commercial enterprises.

28. The system as claimed in claim 27, wherein the event is related to the sales or leasing of real property and the organizational entity provides services in the real estate sales and leasing field.

29. The system as claimed in claim 22, wherein the data input is accomplished by a means selected from the group consisting of keyboard entry, touchscreen entry, optical character recognition scanning, file scanning, downloading from a previously created database, audio file entry, video file entry, and combinations thereof.

30. The system as claimed in claim 22, further comprising:
e. means for making the informational materials available for viewing over a computer network.

31. The system as claimed in claim 22, further comprising:
e. means for transmitting the informational materials over a computer network.

32. The system as claimed in claim 22, further comprising:
e. means for making the informational materials available for viewing over a computer network and transmitting the informational materials over a computer network.

33. A computerized system for the creation and dispersing of informational materials regarding the sales and leasing of real property comprising:
a. means for entering data regarding selected specifics related to at least one piece of real property and/or at least one event related to the sales or leasing of real property, and for entering selected specifics related to at least one organizational entity into a digital computational and storage device;
b. a digital template for organizing the data regarding specifics;
c. means for organizing the data regarding specifics into the digital template; and
d. means for creating the informational materials based on the data regarding specifics organized into the digital template,
wherein the informational materials comprises an electronic version of the data regarding specifics combined with the digital template.

34. The system as claimed in claim 33, wherein the informational materials comprises a plurality of discrete sections, at least a first of which is a section devoted to information regarding the at least one piece of real property and/or the at least one event related to the sales or leasing of real property and at least a second of which is devoted to information regarding an organizational entity selected from the group consisting of entities that provide services in the real estate sales and leasing field.

35. The system as claimed in claim 33, wherein the data input is accomplished by a means selected from the group consisting of keyboard entry, touchscreen entry, optical character recognition scanning, file scanning, downloading from a previously created database, audio file entry, video file entry, and combinations thereof.

36. The system as claimed in claim 33, further comprising:
e. means for making the informational materials available for viewing over a computer network.

37. The system as claimed in claim 33, further comprising:
e. means for transmitting the informational materials over a computer network.

38. The system as claimed in claim 33, further comprising:
e. means for making the informational materials available for viewing over a computer network and transmitting the informational materials over a computer network.

39. A computerized system for the creation and dispersing of informational materials regarding the sales and leasing of real property comprising:
a. means for entering data regarding selected specifics related to at least one piece of real property and/or at least one event related to the sales or leasing of real property, and for entering selected specifics related to at least one organizational entity into a digital computational and storage device;
b. a digital template for organizing the data regarding specifics;
c. means for organizing the data regarding specifics into the digital template; and
d. means for creating the informational materials based on the data regarding specifics organized into the digital template; and
e. means for making the informational materials available for viewing over a computer network,
wherein the informational materials comprises an electronic version of the data regarding specifics combined with the digital template, and the informational materials comprises a plurality of discrete sections, at least a first of which is a section devoted to information regarding the at least one piece of real property and/or the at least one event related to the sales or leasing of real property and at least a second of which is devoted to information regarding an organizational entity selected from the group consisting of entities that provide services in the real estate sales and leasing field.

40. The system as claimed in claim 39, further comprising:
f. means for transmitting the informational materials over the computer network.

41. The system as claimed in claim 40, wherein data input is accomplished by a means selected from the group consisting of keyboard entry, touchscreen entry, optical character recognition scanning, file scanning, downloading from a previously created database, audio file entry, video file entry, and combinations thereof.

42. The system as claimed in claim 41, wherein the data input regarding the selected specifics regarding the at least one piece of real property and/or at least one event related to the sales or leasing of real property is accomplished by downloading from a commercial database dedicated to information regarding real property and the data input regarding the selected specifics regarding the at least one organizational entity is accomplished by downloading from a database previously developed by the at least one organizational entity,
